(19) United States
(12) Patent Application Publication
(10) Pub. No.: US 2018/0160407 A1
(43) Pub. Date: Jun. 7, 2018

(54) BASE STATION, USER EQUIPMENT AND WIRELESS COMMUNICATION METHOD

(71) Applicant: Institute For Information Industry, Taipei (TW)

(72) Inventors: Hai-Han WANG, Taipei City (TW); Chun-Che CHIEN, Taipei City (TW); Yi-Ting LIN, New Taipei City (TW); Chiu-Wen CHEN, Taipei City (TW)

(21) Appl. No.: 15/828,428

(22) Filed: Nov. 30, 2017

Related U.S. Application Data
(60) Provisional application No. 62/428,546, filed on Dec. 1, 2016.

(51) Int. Cl. H04W 72/04

(52) U.S. Cl. CPC H04W 72/042; H04W 72/0453

(57) ABSTRACT

A base station, a user equipment and a wireless communication method are disclosed. The base station sends a first resource configuration to the user equipment so that the base station and the user equipment perform a wireless communication procedure according to the first resource configuration. The base station sends a second resource configuration to the user equipment within a modification period which is used to notify the user equipment that system information will be updated so that the base station and the user equipment perform the wireless communication procedure according to the second resource configuration.

### PRIORITY

This application claims the priority and benefit of U.S. Provisional Patent Application Ser. No. 62/428,546, filed Dec. 1, 2016, and titled “DYNAMIC CARRIER SELECTION FOR MASSIVE NB-IoT CONNECTION”, the entirety of which is incorporated herein by reference.

### FIELD

Embodiments of the present invention relate to a base station, a user equipment and a wireless communication method. More particularly, embodiments of the present invention relate to a base station, a user equipment and a wireless communication method that have dynamic resource configurations.

### BACKGROUND

In conventional wireless communication systems, communication between a user equipment and a base station must rely on system information, especially a resource configuration loaded in the system information. Generally, the base station must first transmit (e.g., broadcast) the system information to the user equipment, and then the user equipment and the base station perform a specific wireless communication procedure together according to the resource configuration in the system information. Besides, in the conventional wireless communication system, if the system information needs to be updated, then the base station first notifies the user equipment that the system information will be updated within a first modification period and then transmits the updated system information to the user equipment within a second modification period that is adjacent to the first modification period. In other words, in the conventional communication system, the first modification period is used to notify the user equipment that the system information will be updated, and the second modification period is used to transmit the updated system information.

In order to change the original resource configuration, the original system information needs to be updated. Once the original system information needs to be updated, the user equipment has to wait for a period of time before receiving the updated system information and the resource configuration that has been changed and loaded in the updated system information. Thus, the above way in which the system information is updated obviously has the following problems. For example, the longer the first modification period is, the later the time at which the user equipment receives the updated system information and the resource configuration that has been changed and loaded in the updated system information is. Additionally, in the case where the system information needs to be updated immediately, e.g., in the case where the original resource configuration is overloaded because of the simultaneous access of a large number of user equipments, the user equipment cannot receive the updated system information and the resource configuration that has been changed and loaded in the updated system information immediately (or within a short period of time) so that the load of the original resource configuration cannot be reduced instantly. Accordingly, an urgent need exists in the art to enable the user equipment to receive the resource configuration that has been changed more efficiently.

### SUMMARY

To solve at least the aforesaid problems, the disclosure includes a base station. The base station may comprise a processor and a transceiver electrically connected with the processor. The processor may be configured to decide a first resource configuration and a second resource configuration. The transceiver may be configured to transmit the first resource configuration to a user equipment, and transmit the second resource configuration to the user equipment within a modification period, which is used to notify the user equipment that system information will be updated, after the first resource configuration is transmitted. After the first resource configuration is received by the user equipment, the processor may perform a wireless communication procedure with the user equipment via the transceiver according to the first resource configuration, and after the second resource configuration is received by the user equipment, the processor may perform the wireless communication procedure with the user equipment via the transceiver according to the second resource configuration.

To solve at least the aforesaid problems, the disclosure also includes a user equipment. The user equipment may comprise a transceiver and a processor electrically connected with the transceiver. The transceiver may be configured to receive a first resource configuration transmitted by a base station and receive a second resource configuration transmitted by the base station within a modification period, which is used to notify the user equipment that system information will be updated, after the first resource configuration is received. The processor may be configured to perform a wireless communication procedure with the base station via the transceiver according to the first resource configuration after the first resource configuration is received by the transceiver, and perform the wireless communication procedure with the base station via the transceiver according to the second resource configuration after the second resource configuration is received by the transceiver.

To solve at least the aforesaid problems, the disclosure further includes a wireless communication method. The wireless communication method may comprise receiving, by a user equipment, a first resource configuration transmitted by a base station; performing, by the user equipment, a wireless communication procedure with the base station according to the first resource configuration after the first resource configuration is received; receiving, by the user equipment, a second resource configuration transmitted by the base station within a modification period, which is used to notify the user equipment that system information will be updated, after receiving the first resource configuration; and performing, by the user equipment, the wireless communication procedure with the base station according to the second resource configuration after receiving the second resource configuration.

To solve at least the aforesaid problems, the disclosure further includes a wireless communication method. The wireless communication method may comprise deciding a first resource configuration and transmitting the first resource configuration to a user equipment by a base station; performing, by the base station, a wireless communication procedure with the user equipment according to the first resource configuration after the first resource configuration is received by the user equipment; deciding by the base station a second resource configuration and transmitting by the base station the second resource configuration to the user equipment within a modification period, which is used to notify the user equipment that system information will be updated, after the first resource configuration is transmitted; and performing, by the base station, the wireless communication procedure with the user equipment according to the second resource configuration after the second resource configuration is received by the user equipment.

According to the above descriptions, the base station transmits the resource configuration that has been modified to the user equipment directly within the first modification period (i.e., a modification period that is used to notify the user equipment that the system information will be updated in the conventional wireless communication system) among two adjacent modification periods, so the user equipment may not need to wait for the second modification period (i.e., a modification period that is used to transmit the updated system information in the conventional wireless communication system) among the two adjacent modification periods before receiving the resource configuration that has been modified. Therefore, in the embodiments disclosed herein, the influence caused by the length of the first modification period to the time at which the resource configuration that has been modified is received by the user equipment can be effectively reduced. Additionally, in these embodiments, in the case where the system information needs to be updated immediately, e.g., in the case where the original resource configuration is overloaded because of the simultaneous access of a large number of user equipments, the user equipment can receive the updated system information and the resource configuration that has been changed and loaded in the updated system information earlier (or within a short period of time) so that the load of the original resource configuration can be reduced instantly.

As compared to the conventional wireless communication system, the disclosed embodiments indeed provide a technology that enables the user equipment to receive the resource configuration that has been changed more efficiently and enables the user equipment to perform the relevant wireless communication procedure according to the resource configuration that has been changed more instantly.

This summary overall describes certain aspects of the present invention and covers the problem to be solved, the means to solve the problem and the effect of the present invention to provide a basic understanding of the present invention by those of ordinary skill in the art. However, it shall be appreciated that, this summary is not intended to encompass all embodiments of the present invention but is provided only to summarize certain aspects of the present invention in a simple form and as an introduction to the following detailed description.

### BRIEF DESCRIPTION OF THE DRAWINGS

FIG. 1 illustrates a schematic view of a wireless communication system in one or more embodiments of the present invention;

FIG. 2 illustrates a schematic view of a wireless communication procedure about paging in one or more embodiments of the present invention;

FIG. 3 is a schematic view illustrating a resource configuration being changed in the wireless communication procedure shown in FIG. 2, in one or more embodiments of the present invention;

FIG. 4 illustrates a schematic view of a wireless communication procedure about random access in one or more embodiments of the present invention;

FIG. 5 is a schematic view illustrating a resource configuration being changed in the wireless communication procedure shown in FIG. 4, in one or more embodiments of the present invention; and

FIG. 6 illustrates a schematic view of a wireless communication method in one or more embodiments of the present invention.

### DETAILED DESCRIPTION

Embodiments of the present invention described below are examples, and are not intended to limit the present invention to any specific example, embodiment, environment, applications, structures, processes or steps described in these example embodiments.

In the attached drawings, elements unrelated to the present invention are omitted from depiction; and dimensions of elements and proportional relationships among individual elements in the attached drawings are only exemplary examples but not intended to limit the present invention. Unless stated particularly, same (or similar) element symbols may correspond to same (or similar) elements in the following description.

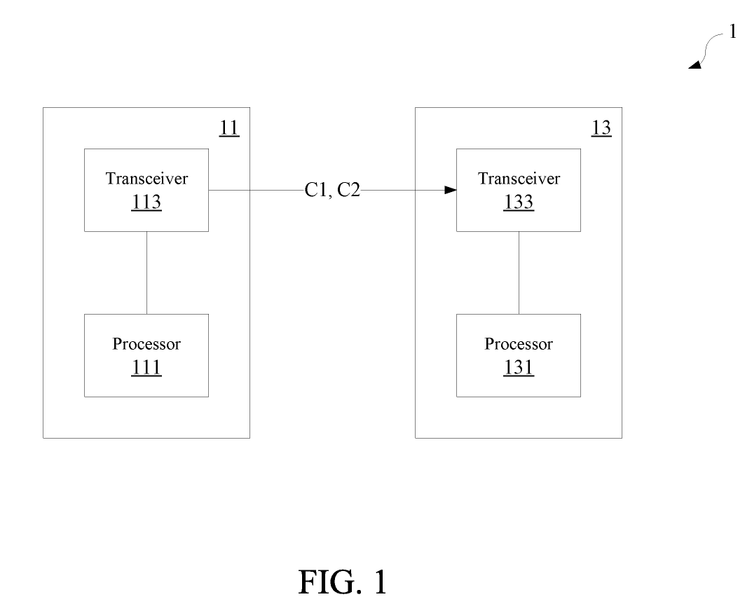

One or more embodiments of the present invention provide a base station and a user equipment under a wireless communication system. FIG. 1 illustrates a schematic view of the wireless communication system in one or more embodiments of the present invention. However, contents shown in FIG. 1 are only for purpose of illustrating embodiments of the present invention instead of limiting the present invention.

Referring to FIG. 1, the wireless communication system 1 may be one of various communication systems constructed under Internet of Things, and it may be for example but not limited to a Narrow Band-IoT (NB-IoT) system, an enhanced Machine-Type Communication (eMTC) system, a massive Machine-Type Communication (mMTC) system or the like.

The wireless communication system 1 may comprise one or more base stations 11, one or more user equipment 13 and a core network (not shown). Each of the base stations 11 may comprise a processor 111 and a transceiver 113 electrically connected to the processor 111. The electrical connection between the processor 111 and the transceiver 113 may be direct connection (i.e., connection not via other elements) or indirect connection (i.e., connection via other elements). Depending on different requirements, the base stations 11 may be various types of base stations which are for example but not limited to: Macrocells, Microcells or Picocells or the like. Each of the user equipments 13 may comprise a processor 131 and a transceiver 133 electrically connected to the processor 131. The electrical connection between the processor 131 and the transceiver 133 may be direct connection (i.e., connection not via other elements) or indirect connection (i.e., connection via other elements). Depending on different requirements, the user equipments 13 may be various electronic devices capable of being networked which are for example but not limited to: mobile phones, tablet computers, notebook computers, various IoT products or the like.

Each of the processors 111 and the processors 131 may be a microprocessor or a microcontroller capable of signal processing. The microprocessor or microcontroller is a programmable specific integrated circuit which is capable of operating, storing, outputting/inputting or the like and may receive and process various encoded instructions, thereby performing various logic operations and arithmetic operations and outputting corresponding operational results. The processor 111 may be programmed to interpret various instructions so as to process data in the base station 11 and execute various operational procedures or programs. The processor 131 may be programmed to interpret various instructions so as to process data in the user equipment 13 and execute various operational procedures or programs.

Each of the transceivers 113 and the transceivers 133 may be constituted by a transmitter and a receiver, and may comprise for example but not limited to communication elements such as an antenna, an amplifier, a modulator, a demodulator, a detector, an analog-to-digital converter, a digital-to-analog converter or the like. The transceiver 113 may be configured to enable the base station 11 to communicate and exchange data with an external device. The transceiver 133 may be configured to enable the user equipment 13 to communicate and exchange data with an external device. For example, as shown in FIG. 1, the transceiver 113 of the base station 11 may communicate with the transceiver 133 of the user equipment 13.

Still referring to FIG. 1, in order to perform a wireless communication procedure with one or more user equipments 13, each of the base stations 11 may decide a first resource configuration C1 via the processor 111 and may transmit (e.g., broadcast) the first resource configuration C1 via the transceiver 113. For example, each of the base stations 11 may load the first resource configuration C1 into system information broadcasted routinely by the base station 11. After the first resource configuration C1 is received by the one or more user equipments 13 via the transceiver 133, the processor 131 can perform a wireless communication procedure with the base station 11 via the transceiver 133 according to the first resource configuration C1.

If the base station 11 wants to change the first resource configuration C1 after the first resource configuration C1 is transmitted, then the base station 11 may decide a second resource configuration C2 via the processor 111 and additionally transmit (e.g., broadcast) the second resource configuration C2 to the one or more user equipments 13 via the transceiver 131 within a modification period that is used to notify the user equipment 13 that the system information will be updated in the conventional communication system. After the second resource configuration C2 is received by the one or more user equipments 13 via the transceiver 133, the processor 131 may continue to perform the wireless communication procedure with the base station 11 via the transceiver 133 according to the second resource configuration C2 instead of according to the first resource configuration C1. Accordingly, the one or more user equipments 13 can receive the second resource configuration C2 (i.e., the resource configuration that has been modified) in advance within the first modification period among two adjacent modification periods in the conventional communication system, and does not need to wait for the second modification period in order to obtain the second resource configuration C2 from the updated system information.

In some embodiments, in addition to the first resource configuration C1 and the second resource configuration C2, the base station 11 may further decide a third resource configuration different from the second resource configuration C2, and transmit (e.g., broadcast) updated system information in which the third resource configuration is loaded to the one or more user equipments 13 via the transceiver 131 within a modification period that is used to transmit the updated system information to the user equipment 13 in the conventional communication system. For example, in the case where system resource congestion is improved because the base station 11 transmits the second resource configuration C2 within the first modification period, the base station 11 can transmit updated system information in which the third resource configuration is loaded to the one or more user equipments 13 within the second modification period. Accordingly, in these embodiments, the one or more user equipments 13 not only can receive the second resource configuration C2 within the first modification period among the two adjacent modification periods in the conventional communication system, but also can obtain the third resource configuration from the updated system information within the second modification period and perform a corresponding communication procedure according to the third resource configuration.

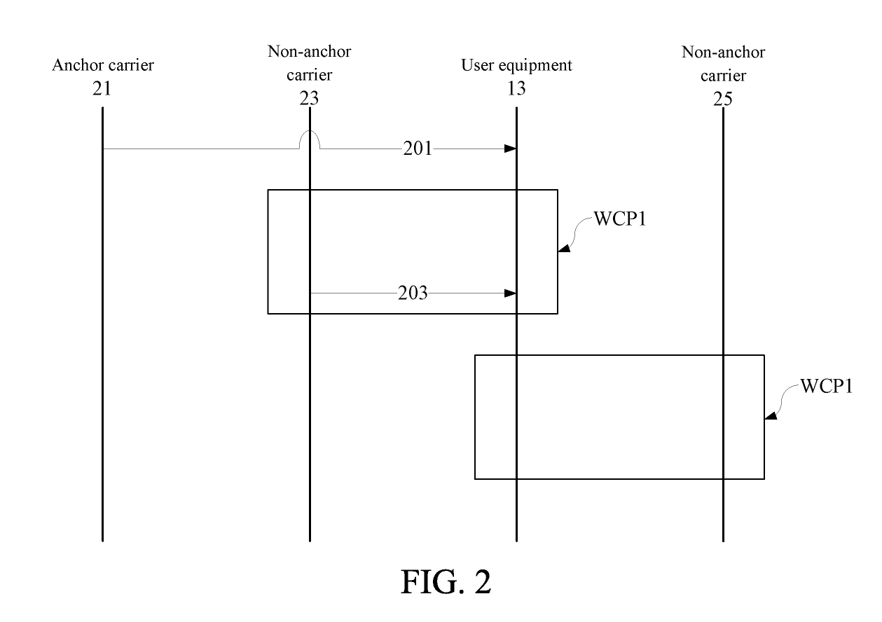

FIG. 2 illustrates a schematic view of a wireless communication procedure about paging in one or more embodiments of the present invention. However, contents shown in FIG. 2 are only for purpose of illustrating embodiments of the present invention instead of limiting the present invention.

Referring to FIG. 1 to FIG. 2, in the case where the wireless communication system 1 provides a plurality of carriers, the base station 11 may place the first resource configuration C1 into a system information message 201 and may transmit the system information message 201 to the user equipment 13 via an anchor carrier 21. After the system information message 201 is received by the user equipment 13, the base station 11 and the user equipment 13 can perform a wireless communication procedure WCP1 about paging according to a certain carrier specified by the first resource configuration C1 (e.g., a non-anchor carrier 23 shown in FIG. 2). In other embodiments, the carrier specified by the first resource configuration C1 may also be the anchor carrier 21. Depending on different requirements, the first resource configuration C1 may comprise different system resource blocks. For example, in order to perform the wireless communication procedure WCP1 about paging, the first resource configuration C1 may comprise: a System Information Block Type 2 (SIB2), a System Information Block Type 2-NB (SIB2-NB) or a System Information Block Type 22-NB (SIB22-NB).

If the base station 11 wants to change the first resource configuration C1 after the system information message 201 is transmitted, then the base station 11 may place the second resource configuration C2 into a downlink control message 203, and transmit the downlink control message 203 to the user equipment 13 via the carrier specified by the first resource configuration C1 (e.g., the non-anchor carrier 23 shown in FIG. 2) within a modification period that is used to notify the user equipment 13 that the system information will be updated in the conventional communication system. After the downlink control message 203 is received by the user equipment 13 via the carrier specified by the first resource configuration C1, the base station 11 can continue to perform the wireless communication procedure WCP1 with the user equipment 13 according to a certain carrier specified by the second resource configuration C2 (e.g., a non-anchor carrier 25 shown in FIG. 2). In other embodiments, the carrier specified by the second resource configuration C2 may also be the anchor carrier 21.

Depending on different requirements, the downlink control message 203 may be a message based on any of the following layers/categories: a physical layer (belonging to Layer 1), a Medium Access Control (MAC) layer (belonging to Layer 2), and a Radio Resource Control (RRC) layer (belonging to Layer 3) or the like. In other embodiments, the downlink control message 203 may also be a downlink control message based on other layers/categories instead of being limited to the aforesaid layers/categories.

In some embodiments, the base station 11 may transmit the downlink control message 203 to the user equipment 13 during the wireless communication procedure WCP1. For example, the downlink control message 203 may be a paging message that is transmitted to the user equipment 13 by the base station 11 during the wireless communication procedure WCP1, and the paging message is a message based on the radio resource control layer and may include paging records of one or more user equipments. As another example, the downlink control message 203 may be a direct instruction that is transmitted additionally to the user equipment 13 by the base station 11 during the wireless communication procedure WCP1, and the direct instruction is a message based on the physical layer. As yet another example, the downlink control message 203 may be an MAC control element (MAC CE) message that is transmitted additionally to the user equipment 13 by the base station 11 during the wireless communication procedure WCP1, or the downlink control message 203 may be an MAC control element message loaded in the paging message that is transmitted to other user equipments 13 by the base station 11 during the wireless communication procedure WCP1, and the MAC control element message is a message based on the medium access control layer.

In some embodiments, the base station 11 may transmit the downlink control message 203 to the user equipment 13 after the system information message 201 is transmitted but before the wireless communication procedure WCP1 is performed. For example, the base station 11 may transmit the direct instruction based on the physical layer or the MAC control element message based on the medium access control layer to the user equipment 13 after the system information message 201 is transmitted but before any paging message is transmitted. In some embodiments, the base station 11 may determine whether to transmit the downlink control message 203 according to a resource utilization condition of the base station 11. For example, the base station 11 may decide to transmit the downlink control message 203 to the user equipment 13 due to one or more of the following reasons: a certain paging message transmitted to the user equipment does not comprise a paging record that is consistent with the user equipment identity of the user equipment 13, a certain carrier (e.g., the non-anchor carrier 23) is overloaded, a certain carrier (e.g., the non-anchor carrier 23) has a poor channel condition (e.g., there is much interference therein), and the base station 11 needs to reserve a certain carrier (e.g., the non-anchor carrier 23) for other applications, or the like. The base station 11 may also determine whether to transmit the downlink control message 203 to the user equipment 13 due to other reasons instead of being limited to the aforesaid reasons.

In some embodiments, the user equipment 13 may decide whether to perform the wireless communication procedure WCP1 according to the second resource configuration C2 (i.e., instead of performing the wireless communication procedure WCP1 according to the first resource configuration C1) depending on a communication condition of the user equipment 13 after the downlink control message 203 is received. For example, the user equipment 13 may perform the wireless communication procedure WCP1 according to the second resource configuration C2 instead of according to the first resource configuration C1 because a certain paging message received from the base station 11 does not comprise a paging record that is consistent with the user equipment identity of the user equipment 13. In some embodiments, the first resource configuration C1 may comprise a first correspondence table regarding a plurality of user equipments 13 and a plurality of carriers, and each of the user equipments 13 can perform the wireless communication procedure WCP1 with the base station 11 directly via a carrier specified in the first correspondence table after receiving the first resource configuration C1. Additionally, the second resource configuration C2 may comprise a second correspondence table regarding the plurality of user equipments 13 and the plurality of carriers, and each of the user equipments 13 can perform the wireless communication procedure WCP1 with the base station 11 directly via a carrier specified in the second correspondence table after receiving the second resource configuration C2.

In some embodiments, in order to reduce the data amount to be transmitted for indicating the aforesaid first correspondence table and the second correspondence table, the first resource configuration C1 may instead comprise a first carrier list, and the first carrier list may record a plurality of carriers (e.g., the anchor carrier 21, the non-anchor carrier 23 and the non-anchor carrier 25 or the like shown in FIG. 2) and respective first weight factors of the plurality of carriers. In this case, the use equipment 13 may select a carrier (e.g., the non-anchor carrier 23 shown in FIG. 2) from the plurality of carriers according to the plurality of first weight factors and the user equipment identity, and then perform the wireless communication procedure WCP1 with the base station 11 via the carrier. Similarly, the second resource configuration C2 may instead comprise a second carrier list, and the second carrier list may record the plurality of carriers and respective second weight factors of the plurality of carriers. In this case, the use equipment 13 may select another carrier (e.g., the non-anchor carrier 25 shown in FIG. 2) from the plurality of carriers according to the plurality of second weight factors and the user equipment identity, and then perform the wireless communication procedure WCP1 with the base station 11 via the another carrier.

In some embodiments, the aforesaid second carrier list may instead record a delta weight factor of each of the carriers. In this case, the user equipment 13 may perform the wireless communication procedure WCP1 with the base station 11 according to the first resource configuration C1 (i.e., the first weight factors of the carriers recorded in the first carrier list) and the second resource configuration C2 (i.e., the delta weight factors of the carriers recorded in the second carrier list).

In some embodiments, the user equipment 13 may select a carrier wi (e.g., the non-anchor carrier 23 or the non-anchor carrier 25 shown in FIG. 2) from the plurality of carriers according to the following condition to perform the wireless communication procedure WCP1 with the base station 11:

$${\sum }_{j = 0}^{i - 1} wj \leq floor ( \frac{UE\_ID}{N \times {N}_{s}} ) mod ( {\sum }_{j} wj ) < {\sum }_{j = 0}^{i} wj \qquad ( 1 )$$

where wj is a weight factor of the J^{th} carrier and is a positive integer, j=1, 2, 3 . . . , and w0=0;
N is the number of paging frames in a paging cycle of the user equipment 13, and it is calculated by taking a minimum value from the number of frames (T) within a discontinuous receive cycle (DRX cycle) of the user equipment and the number of paging subframes (n_{b}) within each paging cycle of the user equipment 13, i.e., min(T, n_{b});
Nₛ is the number of paging subframes in a wireless frame for paging, and it is calculated by taking a maximum value from the value obtained through dividing the number of paging subframes in each paging cycle of the user equipment 13 by the number of frames within the DRX cycle of the user equipment 13 and 1, i.e., max(1, n_{b}/T);
UE_ID is the user equipment ID obtained through moding an international mobile subscriber identity (IMSI) of the user equipment 13 by 16384;
mod operation is the modulo operation; and
floor function takes an integral value not greater than an incoming parameter thereof.

For example, it is assumed that in the first resource configuration C1, the weight factor of the anchor carrier 21 is w1=1, the weight factor of the non-anchor carrier 23 is w2=1, the weight factor of the non-anchor carrier 25 is w3=1, the number of frames (T) within the DRX cycle of the user equipment 13 is 128, the number of paging subframes (n_{b}) in each paging period of the user equipment 13 is 32 (i.e., the value obtained through dividing T by 4), and the number of paging frames (N) in the paging period of the user equipment 13 is 32, then the user equipment 13 of which the UE_ID satisfies the above condition will select the anchor carrier 21 for performing the wireless communication procedure WCP1, wherein i=0, 1, 2, . . . . In this example, a plurality of user equipments of which the UE_ID satisfies the above equation (e.g., the UE_ID is 96-127, 192-223, 288-319, 384-415, 480-511, . . . ) will all select the anchor carrier 21 for performing the paging procedure. If the second resource configuration C2 is transmitted in a paging occasion of a plurality of user equipments (e.g., the UE_ID is 97, 193, 289, 385, 481, . . . ) having the same values calculated from UE_ID mod N and the weight factor w2 of the non-anchor carrier 23 is changed into 2 in the second resource configuration C2, then a plurality of user equipments which have received the second resource configuration C2 and of which the UE_ID is 97, 481, . . . will instead select the non-anchor carrier 23 for performing the wireless communication procedure WCP1.

In some embodiments, after transmitting the system information message 201, the base station 11 may repeatedly transmit the downlink control message 203 and the second resource configuration C2 loaded in the downlink control message 203 to the user equipment 13 at a plurality of time points within a modification period that is used to notify the user equipment 13 that the system information will be updated in the conventional communication system, and the user equipment 13 may receive or attempt to receive the downlink control message 203 and the second resource configuration C2 loaded in the downlink control message 203 at the plurality of time points within the modification period.

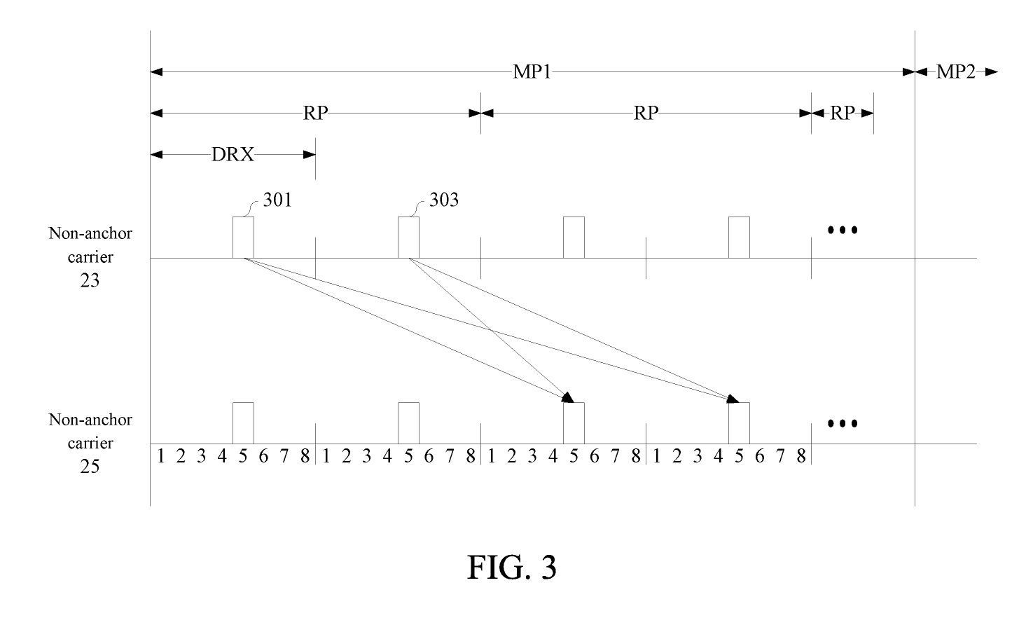

FIG. 3 is a schematic view illustrating a resource configuration being changed in the wireless communication procedure WCP1 shown in FIG. 2, in one or more embodiments of the present invention. However, contents shown in FIG. 3 are only for purpose of illustrating embodiments of the present invention instead of limiting the present invention.

Referring to FIG. 1 to FIG. 3, after receiving the system information message 201 transmitted by the base station 11, the user equipment 13 may receive or attempt to receive a paging message transmitted by the base station 11 at a specific paging occasion within each discontinuous receive cycle DRX on the non-anchor carrier 23 specified by the first resource configuration C1 so as to perform the wireless communication procedure WCP1 about paging with the base station 11. Each discontinuous receive cycle DRX may comprise a plurality of paging occasions (e.g., eight paging occasions) therein, and the specific paging occasion may be any of the plurality of paging occasions (e.g., the fifth paging occasion among the eight paging occasions).

Still referring to FIG. 1 to FIG. 3, after transmitting the system information message 201, the base station 11 may transmit, on the non-anchor carrier 23 specified by the first resource configuration C1, a paging message in which the second resource configuration C2 is loaded (i.e., a certain type of the downlink control message 203) to the user equipment 13 at a specific paging occasion (e.g., specific paging occasions 301 and 303 shown in FIG. 3) of each discontinuous receive cycle DRX in a redistribution period RP within the modification period MP1. After receiving the downlink control message 203 transmitted by the base station 11, the user equipment 13 may receive or attempt to receive a paging message transmitted by the base station 11 at a specific paging occasion within each discontinuous receive cycle DRX on the non-anchor carrier 25 specified by the second resource configuration C2 so as to continue the wireless communication procedure WCP1 about paging with the base station 11. Accordingly, the base station 11 may not need to wait for a modification period MP2, that is used to transmit the updated system information in the conventional communication system, before transmitting the second resource configuration C2 to the user equipment 13, and the user equipment 13 may not need to wait for the modification period MP2 before receiving the second resource configuration C2.

The length of the redistribution period RP may be the same as the length of the discontinuous receive cycle DRX, or may be an integral multiple of the discontinuous receive cycle DRX. In the case where the length of the redistribution period RP is the same as the length of the discontinuous receive cycle DRX, the base station 11 may transmit the downlink control message 203 at a specific paging occasion of a single discontinuous receive cycle DRX (e.g., at the fifth paging occasion of a single discontinuous receive cycle DRX) within the redistribution period RP, and the user equipment 13 may receive or attempt to receive the downlink control message 203 at the specific paging occasion. In the case where the length of the redistribution period RP is an integral multiple of the length of the discontinuous receive cycle DRX, the base station 11 may transmit the downlink control message 203 at a specific paging occasion of each of a plurality of discontinuous receive cycles DRX (e.g., at the fifth paging occasion of each of a plurality of discontinuous receive cycles DRX), and the user equipment 13 may receive or attempt to receive the downlink control message 203 at the plurality of specific paging occasions. If the user equipment 13 receives the downlink control message 203 and the second resource configuration C2 loaded in the downlink control message 203 at any of the plurality of transmission occasions, then the user equipment 13 may start to continue the wireless communication procedure WCP1 about paging with the base station 11 instead on the non-anchor carrier 25 specified by the second resource configuration C2 after the redistribution period RP in which the second resource configuration C2 is received. In some embodiments, when the user equipment 13 is performing the wireless communication procedure WCP1 about paging with the base station 11 according to the second resource configuration C2, the base station 11 may also transmit another resource configuration to the user equipment 13 on other redistribution period(s) RP within the modification period MP1 so that the user equipment 13 can continue the wireless communication procedure WCP1 about paging with the base station 11 instead on the carrier (e.g., the non-anchor carrier 23) specified by the another resource configuration within the modification period MP1.

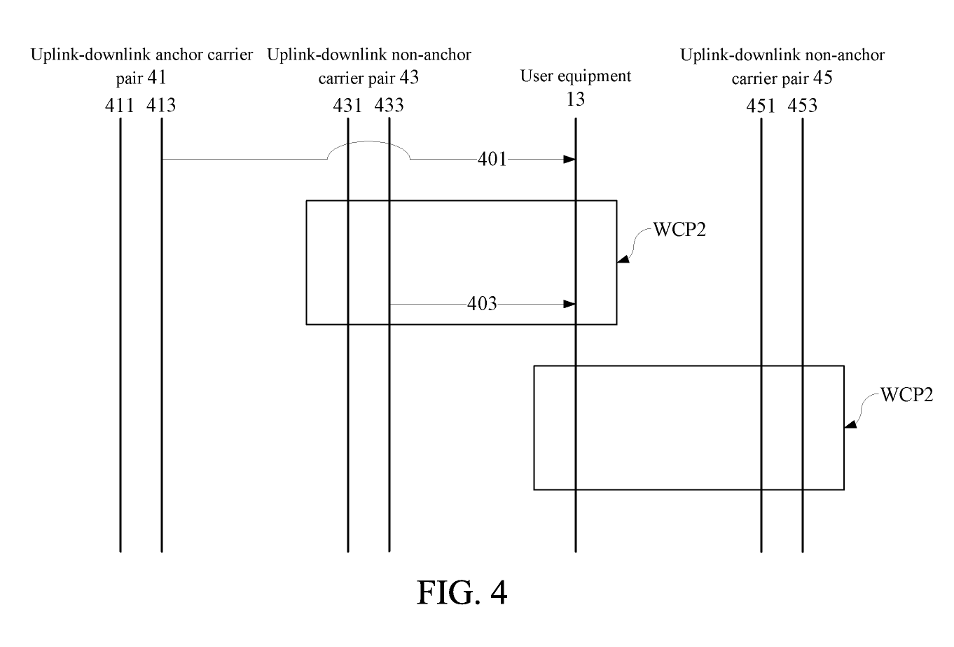

FIG. 4 illustrates a schematic view of a wireless communication procedure about random access in one or more embodiments of the present invention. However, contents shown in FIG. 4 are only for purpose of illustrating embodiments of the present invention instead of limiting the present invention.

Referring to FIG. 1 and FIG. 4, in the case where the wireless communication system 1 provides a plurality of uplink-downlink carrier pairs, the base station 11 may place the first resource configuration C1 in a system information message 401, and transmit the system information message 401 to the user equipment 13 via a downlink anchor carrier 413 comprised in an uplink-downlink anchor carrier pair 41. After the user equipment 13 receives the system information message 401, the base station 11 and the user equipment 13 can perform a wireless communication procedure WCP2 about random access according to a certain uplink-downlink carrier pair specified by the first resource configuration C1 (e.g., an uplink-downlink non-anchor carrier pair 43 shown in FIG. 4), and wherein the uplink-downlink non-anchor carrier pair 43 comprises an uplink non-anchor carrier 431 and a downlink non-anchor carrier 433. In other embodiments, the carrier pair specified by the first resource configuration C1 may also be the uplink-downlink anchor carrier pair 41.

Depending on different requirements, the first resource configuration C1 may comprise different system resource blocks. For example, in order to perform the wireless communication procedure WCP2 about random access, the first resource configuration C1 may comprise: a System Information Block Type 2 (SIB2), a System Information Block Type 2-NB (SIB2-NB) or a System Information Block Type 22-NB (SIB22-NB).

If the base station 11 wants to change the first resource configuration C1 after the system information message 401 is transmitted, then the base station 11 may place the second resource configuration C2 into a downlink control message 403, and transmit the downlink control message 403 to the user equipment 13 via a downlink carrier specified by the first resource configuration C1 (e.g., the downlink non-anchor carrier 433 shown in FIG. 4) within a modification period that is used to notify the user equipment 13 that the system information will be updated in the conventional communication system. After the downlink control message 403 is received by the user equipment 13 via the downlink carrier specified by the first resource configuration C1, the base station 11 can continue to perform the wireless communication procedure WCP2 with the user equipment 13 according to a certain uplink-downlink carrier pair specified by the second resource configuration C2 (e.g., an uplink-downlink non-anchor carrier pair 45 shown in FIG. 4), and wherein the uplink-downlink non-anchor carrier pair 45 comprises an uplink non-anchor carrier 451 and a downlink non-anchor carrier 453. In other embodiments, the uplink-downlink carrier pair specified by the second resource configuration C2 may also be the uplink-downlink anchor carrier pair 41.

Depending on different requirements, the downlink control message 403 may be a message based on any of the following layers/categories: a physical layer and a Medium Access Control layer. In other embodiments, the downlink control message 403 may also be a downlink control message based on other layers/categories instead of being limited to the aforesaid layers/categories.

In some embodiments, the base station 11 may transmit the downlink control message 403 to the user equipment 13 during the wireless communication procedure WCP2. For example, the downlink control message 403 may be a random access response message that is transmitted by the base station 11 in response to a random access preamble message transmitted by the user equipment 13 during the wireless communication procedure WCP2, and the random access response message is a message based on the Medium Access Control layer. As another example, the downlink control message 403 may be a downlink control message, e.g., a message based on the physical layer, that is transmitted additionally to the user equipment 13 by the base station 11 during the wireless communication procedure WCP2.

In some embodiments, each of the plurality of uplink-downlink carrier pairs (e.g., the uplink-downlink anchor carrier pair 41, the uplink-downlink non-anchor carrier pair 43 and the uplink-downlink non-anchor carrier pair 45 or the like) may be replaced by a single carrier, and the single carrier may process uplink transmission and downlink transmission by using Time-Division Duplexing (TDD). For example, the user equipment 13 may transmit a random access preamble message to the base station 11 via a certain carrier within a first time period (uplink transmission), and the base station 11 may transmit a random access response message to the user equipment 13 subsequently via the same carrier within a second time period (downlink transmission).

In some embodiments, the base station 11 may transmit the downlink control message 403 to the user equipment 13 after the system information message 401 is transmitted but before the wireless communication procedure WCP2 is performed. For example, the base station 11 may transmit a message based on the physical layer to the user equipment 13 after it transmits the system information message 401 but before the user equipment 13 transmits any random access preamble message.

In some embodiments, the base station 11 may determine whether to transmit the downlink control message 403 according to a resource utilization condition of the base station 11. For example, the base station 11 may decide to transmit the downlink control message 403 to the user equipment 13 due to one or more of the following reasons: a random access response message transmitted in response to a random access preamble message transmitted by the user equipment 13 does not comprise a random access preamble ID (RAPID) that is consistent with the random access preamble message, a certain uplink-downlink carrier pair (e.g., the uplink-downlink non-anchor carrier pair 43) is overloaded, a certain uplink-downlink carrier pair (e.g., the uplink-downlink non-anchor carrier pair 43) has a poor channel condition (e.g., there is much interference therein), and the base station 11 needs to reserve a certain uplink-downlink carrier pair (e.g., the uplink-downlink non-anchor carrier pair 43) for other applications, or the like. The base station 11 may also determine whether to transmit the downlink control message 403 to the user equipment 13 due to other reasons instead of being limited to the aforesaid reasons.

The base station 11 may determine whether a certain uplink-downlink carrier pair (e.g., the uplink-downlink non-anchor carrier pair 43) is overloaded according to one or more of the following factors: the number and power level of random access preamble messages received on a certain uplink non-anchor carrier; and the success rate of contention resolution for the third type of messages (MSG3) received on a certain uplink non-anchor carrier or the like.

In some embodiments, the user equipment 13 may determine whether to perform the wireless communication procedure WCP2 according to the second resource configuration C2 (i.e., instead of performing the wireless communication procedure WCP2 according to the first resource configuration C1) according to a communication condition of the user equipment 13. For example, the user equipment 13 may decide to perform the wireless communication procedure WCP2 according to the second resource configuration C2 instead of according to the first resource configuration C1 due to one or more of the following reasons: a random access response message received from base station 11 does not comprise a random access preamble ID that is consistent with the first random access preamble message transmitted by the user equipment 13, a certain uplink-downlink carrier pair specified by the second resource configuration C2 (e.g., the uplink-downlink non-anchor carrier pair 43) has a poor channel condition (e.g., there is much interference therein) or the like. The user equipment 13 may also determine whether to perform the wireless communication procedure WCP2 according to the second resource configuration C2 instead of according to the first resource configuration C1 due to other reasons instead of being limited to the aforesaid reasons.

In some embodiments, the first resource configuration C1 may comprise a first correspondence table regarding a plurality of user equipments 13 and a plurality of uplink-downlink carrier pairs, and each of the user equipments 13 can perform the wireless communication procedure WCP2 with the base station 11 directly via an uplink-downlink carrier pair specified in the first correspondence table after receiving the first resource configuration C1. Additionally, the second resource configuration C2 may comprise a second correspondence table regarding the plurality of user equipments 13 and the plurality of uplink-downlink carrier pairs, and each of the user equipments 13 can perform the wireless communication procedure WCP2 with the base station 11 directly via an uplink-downlink carrier pair specified in the second correspondence table after receiving the second resource configuration C2.

In some embodiments, in order to reduce the data amount to be transmitted for indicating the aforesaid first correspondence table and the second correspondence table, the first resource configuration C1 may instead comprise a first carrier list, and the first carrier list may record a plurality of uplink-downlink carrier pairs (e.g., uplink-downlink anchor carrier pair 41, the uplink-downlink non-anchor carrier pair 43, the uplink-downlink non-anchor carrier pair 45 or the like shown in FIG. 4) and respective first weight factors of the plurality of uplink-downlink carrier pairs. In this case, the use equipment 13 may select an uplink-downlink carrier pair (e.g., the uplink-downlink non-anchor carrier pair 43 shown in FIG. 4) from the plurality of uplink-downlink carrier pairs according to the plurality of first weight factors, and then perform the wireless communication procedure WCP2 with the base station 11 via the uplink-downlink carrier pair. Similarly, the second resource configuration C2 may instead comprise a second carrier list, and the second carrier list may record the plurality of uplink-downlink carrier pairs and respective second weight factors of the plurality of uplink-downlink carrier pairs. In this case, the use equipment 13 may select another uplink-downlink carrier pair (e.g., the uplink-downlink non-anchor carrier pair 45 shown in FIG. 4) from the plurality of uplink-downlink carrier pairs according to the plurality of second weight factors, and then continue the wireless communication procedure WCP2 with the base station 11 via the another uplink-downlink carrier pair.

In some embodiments, the user equipment 13 may select an uplink-downlink carrier pair (e.g., the uplink-downlink non-anchor carrier pair 43 or the uplink-downlink non-anchor carrier pair 45 shown in FIG. 4) from the plurality of uplink-downlink carrier pairs according to the following condition to perform the wireless communication procedure WCP2 with the base station 11:

$${\sum }_{j = 0}^{i - 1} \frac{{w}_{{jx}_{j}}}{\sum {w}_{{jx}_{j}}} \leq n < {\sum }_{j = 0}^{i} \frac{{w}_{{jx}_{j}}}{\sum {w}_{{jx}_{j}}} \qquad ( 2 )$$

where wⱼₓ_{ⱼ} is a weight factor of the xⱼ^{th} Random Access Channel resource (RACH resource) selected by the UE in the j^{th} carrier pair, wherein j=1, 2, 3, . . . , and w₀ₓ_{₀}=0; and
n is a number decided by the user equipment 13 randomly from 0 to 1.

For example, it is assumed that the weight factors of two random access channel resources of the uplink-downlink anchor carrier pair 41 under two different Coverage Enhancement (CE) levels are respectively w10=1 and w11=1, the weight factors of random access channel resources of the uplink-downlink non-anchor carrier pair 43 under three different CE levels are respectively w20=2, w21=2, and w22=3, and the weight factors of random access channel resources of the uplink-downlink non-anchor carrier pair 45 under three different CE levels are respectively w30=1, w31=2, and w32=2, then the user equipment 13 first decides the CE levels of the uplink anchor carrier 411 and the uplink non-anchor carriers 431 and 451 according to a reference signal received power (RSRP) measured on the downlink anchor carrier 413 and the downlink non-anchor carriers 433 and 453 as well as a result of comparing a power offset corresponding to the uplink anchor carrier 411 and the uplink non-anchor carriers 431 and 451 in the system information configuration with a threshold, and selects corresponding weight factors according to the decided CE levels, e.g., the user equipment 13 may select the weight factors w10, w21 and w32. Then, if the number n decided by the user equipment randomly from 0 to 1 is 0.5, then the user equipment 13 may select the uplink-downlink non-anchor carrier pair 43 of which the random access channel resource has a weight factor of w21=2 to perform the wireless communication procedure WCP2 with the base station 11.

In some embodiments, after transmitting the system information message 401, the base station 11 may repeatedly transmit the downlink control message 403 and the second resource configuration C2 loaded in the downlink control message 403 to the user equipment 13 at a plurality of time points within a modification period that is used to notify the user equipment 13 that the system information will be updated in the conventional communication system, and the user equipment 13 may receive the downlink control message 403 and the second resource configuration C2 loaded in the downlink control message 403 at the plurality of time points within the modification period.

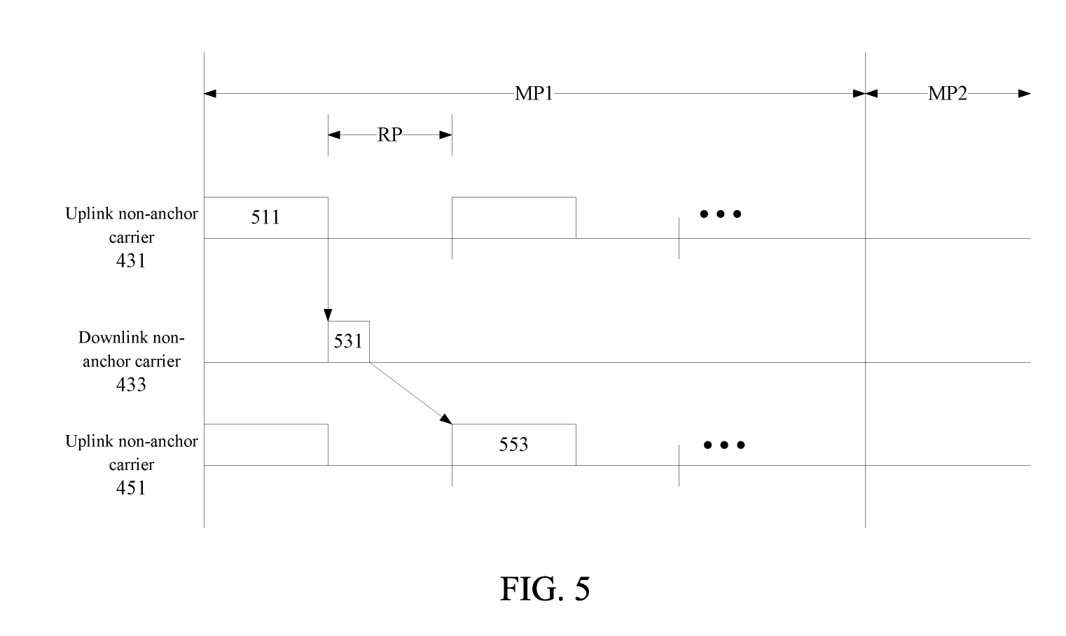

FIG. 5 is a schematic view illustrating a resource configuration being changed in the wireless communication procedure WCP2 shown in FIG. 4, in one or more embodiments of the present invention. However, contents shown in FIG. 5 are only for purpose of illustrating embodiments of the present invention instead of limiting the present invention. For ease of description, FIG. 5 only depicts the uplink non-anchor carrier pair 431, the downlink non-anchor carrier pair 433 and the uplink non-anchor carrier pair 451 under a single CE level.

Referring to FIG. 1, FIG. 4 and FIG. 5, after receiving the system information message 401 transmitted by the base station 11, the user equipment 13 may perform the wireless communication procedure WCP2 with the base station 11 on the uplink-downlink non-anchor carrier pair 43 specified by the first resource configuration C1. In the wireless communication procedure WCP2, the user equipment 13 first transmits a random access preamble message (i.e., a first message (MSG1)) to the base station 11 on the uplink non-anchor carrier pair 431, and then the base station 11 transmits a random access response message (i.e., the second message (MSG2)) to the user equipment 13 on the downlink non-anchor carrier pair 433. If the random access response message comprises a random access preamble ID that is consistent with the random access preamble message, then the user equipment 13 and the base station 11 will continue the subsequent random access processing (i.e., the processing of the third message (MSG3) and the fourth message (MSG4)).

Still referring to FIG. 1, FIG. 4 and FIG. 5, after transmitting the system information message 401, the base station 11 may define a redistribution period RP within a modification period MP1 that is used to inform the user equipment 13 that the system information will be updated in the conventional communication system, and transmit the downlink control message 403 to the user equipment 13 on one or more time points or within a time period in the redistribution period RP. For example, if the user equipment transmits a random access preamble message within a time period 511 on the uplink non-anchor carrier 431 specified by the first resource configuration C1, then the base station 11 may transmit a random access response message (i.e., a certain type of the downlink control message 403) in which the second resource configuration C2 is loaded to the user equipment 13 within a time period 531 on the downlink non-anchor carrier 433 specified by the first resource configuration C1. In some embodiments, the redistribution period RP may be a random access response (RAR) window in which the user equipment 13 waits for a random access response message transmitted by the base station 11 on the downlink non-anchor carrier 433.

After receiving the random access response message transmitted by the base station 11, the user equipment 13 may continue the wireless communication procedure WCP2 with the base station 11 instead on the uplink-downlink non-anchor carrier 45 specified by the second resource configuration C2. For example, after receiving the random access response message transmitted by the base station 11, the user equipment 13 may transmit another random access preamble message to the base station 11 within a time period 553 on the uplink non-anchor carrier 451, and wait for a corresponding random access response message transmitted by the base station 11 on the downlink non-anchor carrier 453 before performing the subsequent random access processing (i.e., the processing of the third message (MSG3) and the fourth message (MSG4)) with the base station 11. Accordingly, the base station 11 may not need to wait for a modification period MP2, that is used to transmit the updated system information in the conventional communication system, before transmitting the second resource configuration C2 to the user equipment 13, and the user equipment 13 may not need to wait for the modification period MP2 before receiving the second resource configuration C2.

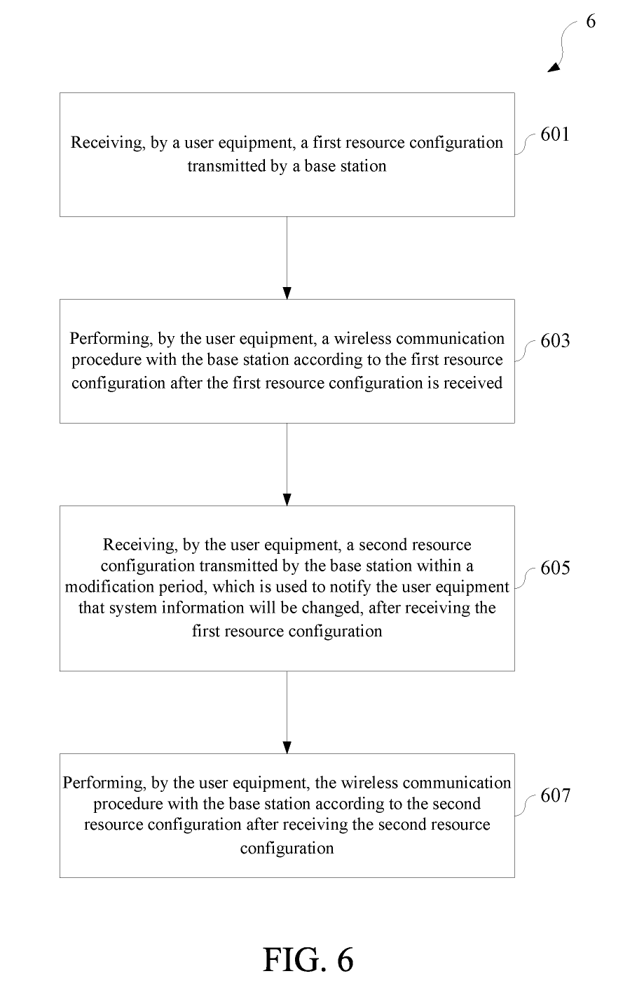

FIG. 6 illustrates a schematic view of a wireless communication method in one or more embodiments of the present invention. However, contents shown in FIG. 6 are only for purpose of illustrating embodiments of the present invention instead of limiting the present invention.

Referring to FIG. 6, a wireless communication method 6 may comprise the following steps:

receiving, by a user equipment, a first resource configuration transmitted by a base station;

performing, by the user equipment, a wireless communication procedure with the base station according to the first resource configuration after the first resource configuration is received;

receiving, by the user equipment, a second resource configuration transmitted by the base station within a modification period, which is used to notify the user equipment that system information will be updated, after receiving the first resource configuration; and

performing, by the user equipment, the wireless communication procedure with the base station according to the second resource configuration after receiving the second resource configuration.

In some embodiments, for the wireless communication method 6, the user equipment may receive the second resource configuration at a plurality of time points within the modification period.

In some embodiments, for the wireless communication method 6, the wireless communication procedure may be a paging procedure, and the user equipment may acquire the second resource configuration from a downlink control message transmitted by the base station. Besides, in these embodiments, the first resource configuration may comprise a first carrier list, and the first carrier list records a plurality of carriers and respective first weight factors of the plurality of carriers; and the second resource configuration may comprise a second carrier list, and the second carrier list records the plurality of carriers and respective second weight factors of the plurality of carriers. The wireless communication method 6 further comprises the following steps: performing, by the user equipment, the wireless communication procedure with the base station on one of the plurality of carriers according to the plurality of first weight factors after receiving the first resource configuration; and performing, by the user equipment, the wireless communication procedure with the base station on one of the plurality of carriers according to the plurality of second weight factors after receiving the second resource configuration.

In some embodiments, for the wireless communication method 6, the wireless communication procedure may be a random access procedure, and the user equipment may acquire the second resource configuration from a downlink control message transmitted by the base station. Besides, in these embodiments, the first resource configuration comprises a first carrier list, and the first carrier list records a plurality of uplink-downlink carrier pairs and respective first weight factors of the plurality of uplink-downlink carrier pairs; and the second resource configuration comprises a second carrier list, and the second carrier list records a plurality of uplink-downlink carrier pairs and respective second weight factors of the plurality of uplink-downlink carrier pairs. The wireless communication method 6 further comprises the following steps: performing, by the user equipment, the wireless communication procedure with the base station on one of the plurality of uplink-downlink carrier pairs according to the plurality of first weight factors after receiving the first resource configuration; and performing, by the user equipment, the wireless communication procedure with the base station on one of the plurality of uplink-downlink carrier pairs according to the plurality of second weight factors after receiving the second resource configuration.

In some embodiments, the wireless communication method 6 may further comprise the following step: determining, by the user equipment according to a communication condition of the user equipment, whether to perform the wireless communication procedure with the base station according to the second resource configuration.

In some embodiments, the wireless communication method 6 may be implemented in the wireless communication system 1. All corresponding steps comprised in the wireless communication method 6 shall be clearly appreciated by those of ordinary skill in the art based on the above description of the wireless communication system 1, and thus will not be further described herein.

One or more embodiments of the present invention may further comprise another wireless communication method. The wireless communication method may comprise the following steps:

deciding a first resource configuration and transmitting the first resource configuration to a user equipment by a base station;

performing, by the base station, a wireless communication procedure with the user equipment according to the first resource configuration after the first resource configuration is received by the user equipment;

deciding by the base station a second resource configuration and transmitting by the base station the second resource configuration to the user equipment within a modification period, which is used to notify the user equipment that system information will be updated, after the first resource configuration is transmitted; and

performing, by the base station, the wireless communication procedure with the user equipment according to the second resource configuration after the second resource configuration is received by the user equipment.

In some embodiments, for the wireless communication method, the base station may repeatedly transmit the second resource configuration at a plurality of time points within the modification period.

In some embodiments, for the wireless communication method, the wireless communication procedure may be a paging procedure, and the base station may load the second resource configuration into a downlink control message transmitted to the user equipment. Besides, in these embodiments, the first resource configuration may comprise a first carrier list, and the first carrier list records a plurality of carriers and respective first weight factors of the plurality of carriers; and the second resource configuration may comprise a second carrier list, and the second carrier list records the plurality of carriers and respective second weight factors of the plurality of carriers. The wireless communication method may further comprise the following steps: performing, by the base station, the wireless communication procedure with the user equipment on one of the plurality of carriers according to the plurality of first weight factors after the user equipment receives the first resource configuration; and performing, by the base station, the wireless communication procedure with the user equipment on one of the plurality of carriers according to the plurality of second weight factors after the user equipment receives the second resource configuration.

In some embodiments, for the wireless communication method, the wireless communication procedure may be a random access procedure, and the base station may load the second resource configuration into a downlink control message transmitted to the user equipment. Besides, in these embodiments, the first resource configuration may comprise a first carrier list, and the first carrier list records a plurality of uplink-downlink carrier pairs and respective first weight factors of the plurality of uplink-downlink carrier pairs; and the second resource configuration may comprise a second carrier list, and the second carrier list records a plurality of uplink-downlink carrier pairs and respective second weight factors of the plurality of uplink-downlink carrier pairs. The wireless communication method may further comprise the following steps: deciding by the base station the plurality of first weight factors and, after the first resource configuration is received by the user equipment, performing by the base station the wireless communication procedure with the user equipment on one of the plurality of uplink-downlink carrier pairs according to the plurality of first weight factors; and deciding by the base station the plurality of second weight factors and, after the second resource configuration is received by the user equipment, performing by the base station the wireless communication procedure with the user equipment on one of the plurality of uplink-downlink carrier pairs according to the plurality of second weight factors.

In some embodiments, the wireless communication method may further comprise the following step: determining, by the base station, whether to transmit the second resource configuration according to a resource utilization condition of the base station.

In some embodiments, the wireless communication method may be implemented in the wireless communication system 1. All corresponding steps comprised in the wireless communication method shall be clearly appreciated by those of ordinary skill in the art based on the above description of the wireless communication system 1, and thus will not be further described herein.

The above disclosure is related to the detailed technical contents and inventive features thereof. People of ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A base station, comprising:
a processor, being configured to decide a first resource configuration and a second resource configuration; and
a transceiver electrically connected with the processor, being configured to transmit the first resource configuration to a user equipment, and transmit the second resource configuration to the user equipment within a modification period, which is used to notify the user equipment that system information will be updated, after the first resource configuration is transmitted;
wherein after the first resource configuration is received by the user equipment, the processor performs a wireless communication procedure with the user equipment via the transceiver according to the first resource configuration, and after the second resource configuration is received by the user equipment, the processor performs the wireless communication procedure with the user equipment via the transceiver according to the second resource configuration.

2. The base station of claim 1, wherein the transceiver repeatedly transmits the second resource configuration to the user equipment at a plurality of time points within the modification period.

3. The base station of claim 1, wherein the wireless communication procedure is a paging procedure, and the transceiver is configured to load the second resource configuration into a downlink control message transmitted to the user equipment.

4. The base station of claim 3, wherein:
the first resource configuration comprises a first carrier list, and the first carrier list records a plurality of carriers and respective first weight factors of the plurality of carriers;
the second resource configuration comprises a second carrier list, and the second carrier list records the plurality of carriers and respective second weight factors of the plurality of carriers;
the processor is further configured to decide the first weight factors and, after the first resource configuration is received by the user equipment, perform the wireless communication procedure with the user equipment via the transceiver on one of the carriers according to the plurality of first weight factors; and
the processor is further configured to decide a plurality of second weight factors and, after the second resource configuration is received by the user equipment, perform the wireless communication procedure with the user equipment via the transceiver on one of the plurality of carriers according to the plurality of second weight factors.

5. The base station of claim 1, wherein the wireless communication procedure is a random access procedure, and the transceiver is configured to load the second resource configuration into a downlink control message transmitted to the user equipment.

6. The base station of claim 5, wherein:
the first resource configuration comprises a first carrier list, and the first carrier list records a plurality of uplink-downlink carrier pairs and respective first weight factors of the plurality of uplink-downlink carrier pairs;
the second resource configuration comprises a second carrier list, and the second carrier list records the plurality of uplink-downlink carrier pairs and respective second weight factors of the plurality of uplink-downlink carrier pairs;
the processor is further configured to decide the plurality of first weight factors and, after the first resource configuration is received by the user equipment, perform the wireless communication procedure with the user equipment via the transceiver on one of the plurality of uplink-downlink carrier pairs according to the plurality of first weight factors; and
the processor is further configured to decide the plurality of second weight factors and, after the second resource configuration is received by the user equipment, perform the wireless communication procedure with the user equipment via the transceiver on one of the plurality of uplink-downlink carrier pairs according to the plurality of second weight factors.

7. The base station of claim 1, wherein the processor is further configured to determine whether to transmit the second resource configuration via the transceiver according to a resource utilization condition of the base station.

8. A user equipment, comprising:
a transceiver, being configured to receive a first resource configuration transmitted by a base station and receive a second resource configuration transmitted by the base station within a modification period, which is used to notify the user equipment that system information will be updated, after the first resource configuration is received; and
a processor electrically connected with the transceiver, being configured to perform a wireless communication procedure with the base station via the transceiver according to the first resource configuration after the first resource configuration is received by the transceiver, and perform the wireless communication procedure with the base station via the transceiver according to the second resource configuration after the second resource configuration is received by the transceiver.

9. The user equipment of claim 8, wherein the transceiver receives the second resource configuration transmitted by the base station at a plurality of time points within the modification period.

10. The user equipment of claim 8, wherein the wireless communication procedure is a paging procedure, and the transceiver acquires the second resource configuration from a downlink control message transmitted by the base station.

11. The user equipment of claim 10, wherein:
the first resource configuration comprises a first carrier list, and the first carrier list records a plurality of carriers and respective first weight factors of the plurality of carriers;
the second resource configuration comprises a second carrier list, and the second carrier list records the plurality of carriers and respective second weight factors of the plurality of carriers;
the processor is further configured to perform the wireless communication procedure with the base station via the transceiver on one of the plurality of carriers according to the plurality of first weight factors after the first resource configuration is received by the transceiver; and
the processor is further configured to perform the wireless communication procedure with the base station via the transceiver on one of the plurality of carriers according to the plurality of second weight factors after the second resource configuration is received by the transceiver.

12. The user equipment of claim 8, wherein the wireless communication procedure is a random access procedure, and the transceiver acquires the second resource configuration from a downlink control message transmitted by the base station.

13. The user equipment of claim 12, wherein:
the first resource configuration comprises a first carrier list, and the first carrier list records a plurality of uplink-downlink carrier pairs and respective first weight factors of the plurality of uplink-downlink carrier pairs;
the second resource configuration comprises a second carrier list, and the second carrier list records the plurality of uplink-downlink carrier pairs and respective second weight factors of the plurality of uplink-downlink carrier pairs;
the processor is further configured to perform the wireless communication procedure with the base station via the transceiver on one of the plurality of uplink-downlink carrier pairs according to the plurality of first weight factors after the first resource configuration is received by the transceiver; and
the processor is further configured to perform the wireless communication procedure with the base station via the transceiver on one of the plurality of uplink-downlink carrier pairs according to the plurality of second weight factors after the second resource configuration is received by the transceiver.

14. The user equipment of claim 12, wherein the processor is further configured to, according to a communication condition of the user equipment, determine whether to perform the wireless communication procedure with the base station via the transceiver according to the second resource configuration.

15. A wireless communication method, comprising:
receiving, by a user equipment, a first resource configuration transmitted by a base station;
performing, by the user equipment, a wireless communication procedure with the base station according to the first resource configuration after the first resource configuration is received;
receiving, by the user equipment, a second resource configuration transmitted by the base station within a modification period, which is used to notify the user equipment that system information will be updated, after receiving the first resource configuration; and
performing, by the user equipment, the wireless communication procedure with the base station according to the second resource configuration after receiving the second resource configuration.

16. The wireless communication method of claim 15, wherein the user equipment receives the second resource configuration at a plurality of time points within the modification period.

17. The wireless communication method of claim 15, wherein the wireless communication procedure is a paging procedure, and the user equipment acquires the second resource configuration from a downlink control message transmitted by the base station.

18. The wireless communication method of claim 17, wherein:
the first resource configuration comprises a first carrier list, and the first carrier list records a plurality of carriers and respective first weight factors of the plurality of carriers;
the second resource configuration comprises a second carrier list, and the second carrier list records the plurality of carriers and respective second weight factors of the plurality of carriers; and
the wireless communication method further comprises the following steps:
performing, by the user equipment, the wireless communication procedure with the base station on one of the plurality of carriers according to the plurality of first weight factors after receiving the first resource configuration; and
performing, by the user equipment, the wireless communication procedure with the base station on one of the plurality of carriers according to the plurality of second weight factors after receiving the second resource configuration.

19. The wireless communication method of claim 15, wherein the wireless communication procedure is a random access procedure, and the user equipment acquires the second resource configuration from a downlink control message transmitted by the base station.

20. The wireless communication method of claim 19, wherein:
the first resource configuration comprises a first carrier list, and the first carrier list records a plurality of uplink-downlink carrier pairs and respective first weight factors of the plurality of uplink-downlink carrier pairs;
the second resource configuration comprises a second carrier list, and the second carrier list records the plurality of uplink-downlink carrier pairs and respective second weight factors of the plurality of uplink-downlink carrier pairs; and
the wireless communication method further comprises the following steps:
performing, by the user equipment, the wireless communication procedure with the base station on one of the plurality of uplink-downlink carrier pairs according to the plurality of first weight factors after receiving the first resource configuration; and
performing, by the user equipment, the wireless communication procedure with the base station on one of the plurality of uplink-downlink carrier pairs according to the plurality of second weight factors after receiving the second resource configuration.

21. The wireless communication method of claim 19, further comprising:
determining, by the user equipment according to a communication condition of the user equipment, whether to perform the wireless communication procedure with the base station according to the second resource configuration.
